(19) United States
(12) Patent Application Publication
(10) Pub. No.: US 2017/0115863 A1
(43) Pub. Date: Apr. 27, 2017

(54) CONFIGURATION CONTROL DISPLAY FOR AN AGRICULTURAL SYSTEM

(71) Applicant: CNH Industrial America LLC, New Holland, PA (US)

(72) Inventors: Natalia Lucas, Mundelein, IL (US); Bushra Ali, Bensenville, IL (US); John Stratton, Denver, CO (US)

(73) Assignee: CNH INDUSTRIAL AMERICA LLC, New Holland, PA (US)

(21) Appl. No.: 14/924,119

(22) Filed: Oct. 27, 2015

(51) Int. Cl. G06F 3/0484; A01B 71/02; G06F 3/0481; G06F 3/14; G06F 3/0482

(52) U.S. Cl. CPC G06F 3/04847; G06F 3/14; G06F 3/0482; G06F 3/04817; G06F 3/04842; A01B 71/02; A01C 5/04

(57) ABSTRACT

An agricultural system including a vehicle, a controller and a display mounted in the vehicle. The display is coupled to the controller. The controller is configured to interact with a user by way of the display using a card manager system. The card manager system is configured to display a hierarchy of setup selections on the display using a plurality of setup cards displayed in a hierarchical manner thereby implying dependency between underlying setup criteria of equipment represented by said setup cards.

### BACKGROUND OF THE INVENTION

1. Field of the Invention

The present invention relates to a controller for an agricultural system, and, more particularly, to a display regime for a data monitor under the control of a controller associated with the agricultural systems.

2. Description of the Related Art

Modern farming practices have developed to improve the speed and efficiency of the farm equipment used to plant, maintain, and harvest crops. For example, tractors include a global positioning system (GPS) and a controller in the tractor is configured to provide a topographical view of a field and to identify the location of the tractor within the field based on the GPS coordinates. In addition, multiple agricultural implements may be connected to the tractor. During planting, for example, the tractor may pull an air cart having multiple containers including one or more types of seed and/or fertilizer. The tractor may also pull a planter to plant the seeds.

The controller on the tractor may be configured to control operation of the implements connected to the tractor. Different models of each implement may include varying operating parameters such as capacity, rate of application, or number of rows. The operating parameters may also depend, for example, on the configuration or operating characteristics of the tractor or the location within the field. Each of the operating parameters needs to be configured prior to operation of the respective implement. Consequently, each implement typically includes a configuration module stored on the controller of the tractor to configure operation of the respective implement.

However, as the number of features on the agricultural implements increase so does the number of operating parameters and the complexity of configuring operation of the tractor and the connected implements. In addition, different implements such as the air cart and planter may interact with each other. Changing the configuration of a parameter on one of the implements may impact operation of the other implement.

In a known type of planting implement, seed planting or row units are attached to a toolbar extending transverse to the direction of planting. The toolbar is coupled to a tractor or other work vehicle suitable for pulling the planting implement along a field that is to be seeded to a crop. Each planting unit includes a ground penetrating assembly, often including one or more discs, for opening a seed trench or furrow in the ground as the planting implement is pulled across a field. Components of the ground penetrating assembly shape the bottom and sides of the seed trench, and a seed-metering device provides individual seeds at a controlled rate for deposit in the seed trench. Furrow closing components of each row unit close the seed trench in a controlled manner.

Agricultural planters are commonly used implements to plant seeds in soil. An agricultural planter can include a chassis that carries one or more storage tanks carrying seed, and chemical applications that are to be applied to the field during the planting operation, a hitch mechanism that attaches to a tractor or other implement pulled by a tractor, and a tool bar that row units can be connected to so they are carried by the chassis. The planter can also include a pneumatic system carried by the chassis that supplies pressurized air to transport the seeds or other particulate from the storage tanks to the row units.

Each row unit of the agricultural planter places seeds in the field. Typically, the row units are laterally arranged along a length of the tool bar so that as the planter is pulled across the field, each row unit plants seeds at predefined intervals along the path it is pulled across. To plant seeds, the row units perform four main operations as they are pulled: opening a trench in the soil; placing a seed into the formed trench at appropriate intervals; closing the formed trench to put soil on top of the placed seed; and packing soil on top of the seed to provide desirable soil contact with the placed seed. To open a trench in the soil, a furrowing disc system, also called an opening disc, cuts into the soil and rotates, dislocating soil as it rotates to form the trench.

Once the trench is open, a seed is placed in the trench by a metering device which receives seeds from the main storage tank(s) or a row unit storage tank and typically utilizes a combination of differential air pressure, to select the seed, and gravity to place the seed in the trench at predefined intervals along the pulled path so that adjacent seeds in the row are not too close to one another. One or more closing discs carried behind the furrowing disc are pressed into the soil and also rotate as the planter is pulled to replace soil dislocated by the furrowing disc in the trench or dislocate adjacent soil into the trench to cover the seed placed in the trench with soil. Finally, at least one pressing wheel carried behind the closing disc(s) exerts pressure on the soil covering the seed to press the soil down onto the seed and provide good soil contact with the seed. By having multiple row units working in unison as the planter is pulled across a field, many seeds can be effectively planted in an efficient manner.

Since a variety of tractors can couple to a variety of implements, such as a planter, the capabilities of the controls and availability of information relative to the operation of the implement/vehicle system creates a problem of adequate displays of information and presentation of controls to a user. The amount of setups that a user has to go through on agricultural equipment may be overwhelming. There is software available that enforces an order of setups before it will operate, but it suffers from not conveying dependencies, nor having an intuitive need for order in the setup process.

What is needed in the art is a robust display that presents setup information and selections in an intuitive and efficient manner.

### SUMMARY OF THE INVENTION

The present invention provides a hierarchical setup display for the configuring of an agricultural system.

The invention in one form is directed to an agricultural system including a vehicle, a controller and a display mounted in the vehicle. The display is coupled to the controller. The controller is configured to interact with a user by way of the display using a card manager system. The card manager system is configured to display a hierarchy of setup selections on the display using a plurality of setup cards displayed in a hierarchical manner thereby implying dependency between underlying setup criteria of equipment represented by said setup cards.

The invention in yet another form is directed to a method of displaying information for an agricultural system that includes a vehicle, a controller and a display mounted in the vehicle. The controller is coupled to the display. The method includes the steps of: interacting with a user using a card manager system, the card manager system being configured to display a plurality of setup cards on the display; and hierarchically displaying the plurality of cards with each card relating to a portion of the agricultural system thereby implying a dependency between at least some of said setup cards.

An advantage of the present invention is that setup information and selections are displayed in a hierarchical fashion thereby implying dependency of the setups and an order in which the setups should take place.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematic representation of a complete agricultural system using an embodiment of a hierarchical setup display of the present invention;

FIG. 2 is a depiction of an implement of FIG. 1 that is coupled to tractor and subject to the configuration selections made on the hierarchical setup display of the present invention;

FIG. 3 is a depiction of a hierarchical setup display illustrating cards displayed under the control of a card manager system;

FIG. 4 is another depiction of the hierarchical setup display of FIG. 3; and

FIG. 5 illustrates another embodiment of a hierarchical setup display of the present invention.

Corresponding reference characters indicate corresponding parts throughout the several views. The exemplification set out herein illustrates one embodiment of the invention, in one form, and such exemplification is not to be construed as limiting the scope of the invention in any manner.

### DETAILED DESCRIPTION OF THE INVENTION

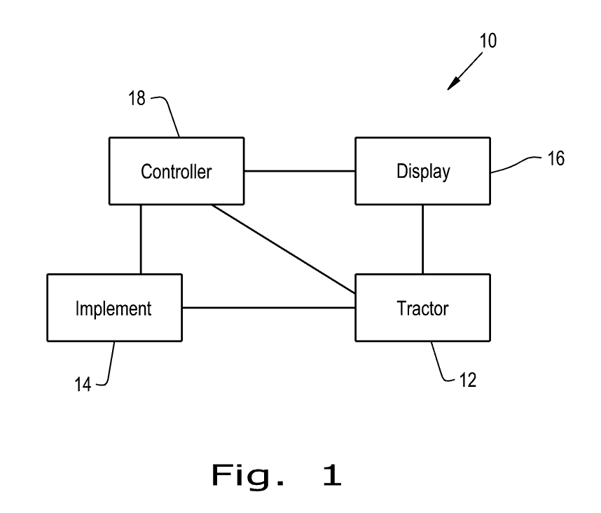

Referring now to the drawings, and more particularly to FIG. 1, there is shown an embodiment of an agricultural system 10 having a tractor 12, an implement 14 and a display 16 that is incorporated in tractor 12. Display 16 is an interactive display 16 configured to provide information to a user and allow the user to direct the operation of tractor 12 and/or implement 14. A controller 18 receives information from sensors on implement 14 and tractor 12, processes, stores and displays selected portions of that information and other stored information such as setup information and configuration selections. The displaying of information and control features on display 16 takes into account needed setup and configuration aspects of the agricultural system 10.

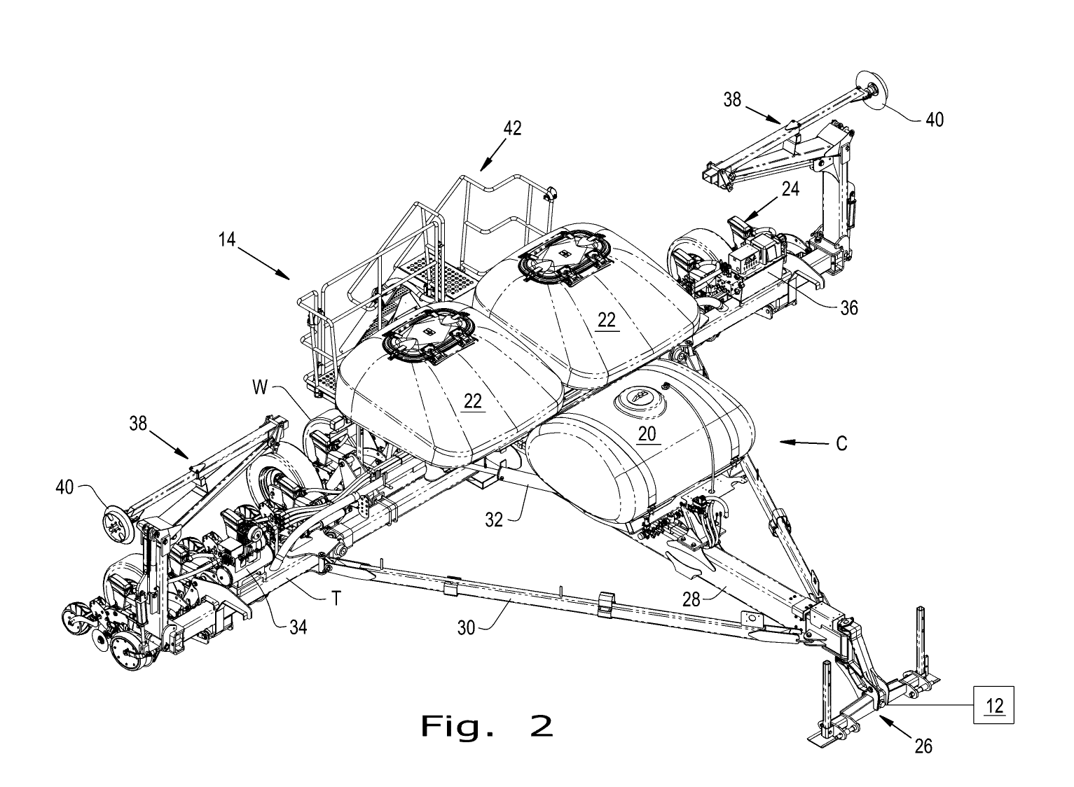

Now, additionally referring to FIG. 2, there is shown some details of a typical implement 14 in the form an agricultural planter 14 which generally includes a chassis C forming a support structure for components of the planter 14 that can be formed by a hitch assembly at a front of the planter 14 connected to a tool bar T, main wheels W carried by the chassis near a rear of the planter 14, one or more storage tanks 20 and 22 that can be filled with seed or other agriculture material carried by the chassis, and a plurality of row units 24 connected to the tool bar T and arranged laterally across a length of the tool bar T so that they are carried by the chassis. The chassis C can include a hitch 26 configured to be connected to a tractor 12 or other agricultural implement (not shown) so that the planter 14 can be pulled in a forward direction of travel. The hitch 26 can be integrally formed with or connected to a hitch bar 28 that is connected to the tool bar T by bracing bars 30 and one or more cylinders 32. As can be seen, the planter 14 can also have various hydraulic, pneumatic, and electrical lines (unnumbered) throughout to support various cylinders and systems that are included on the planter 14, such as a pneumatic system 34 connected to the tool bar T and an electric generator 36 also connected to the tool bar T. A marking device 38 can be connected to each lateral end of the tool bar T and extendable so that a marking disc 40 of the marking device 38 can create a line in the soil as the planter 14 is pulled that helps a user in positioning the planter 14 to create subsequent rows. A stair assembly 42 can be mounted to the back of the planter 14 to allow for an operator to access the storage tanks 22.

While a planter 14 is shown in detail it is to be understood that any agricultural implement 14 can be utilized. Further, although a towing of implement 14 by tractor 12 is illustrated herein it should be understood that tractor 12 may be any agricultural, construction, or forestry vehicle that can be coupled to various implements 14.

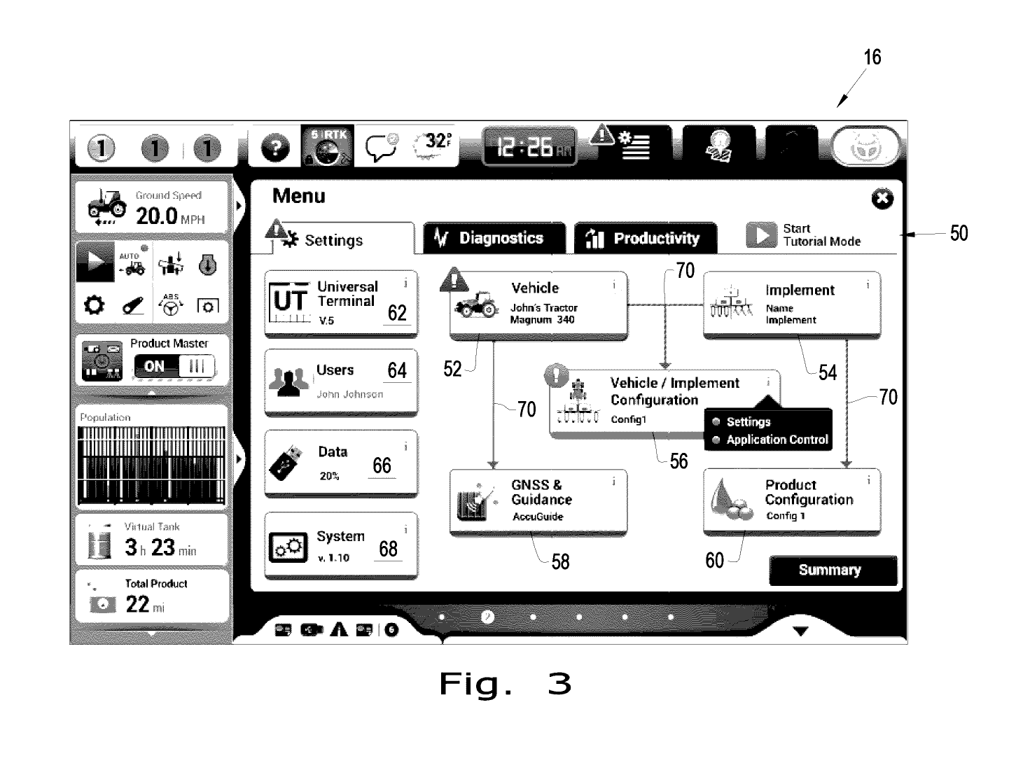

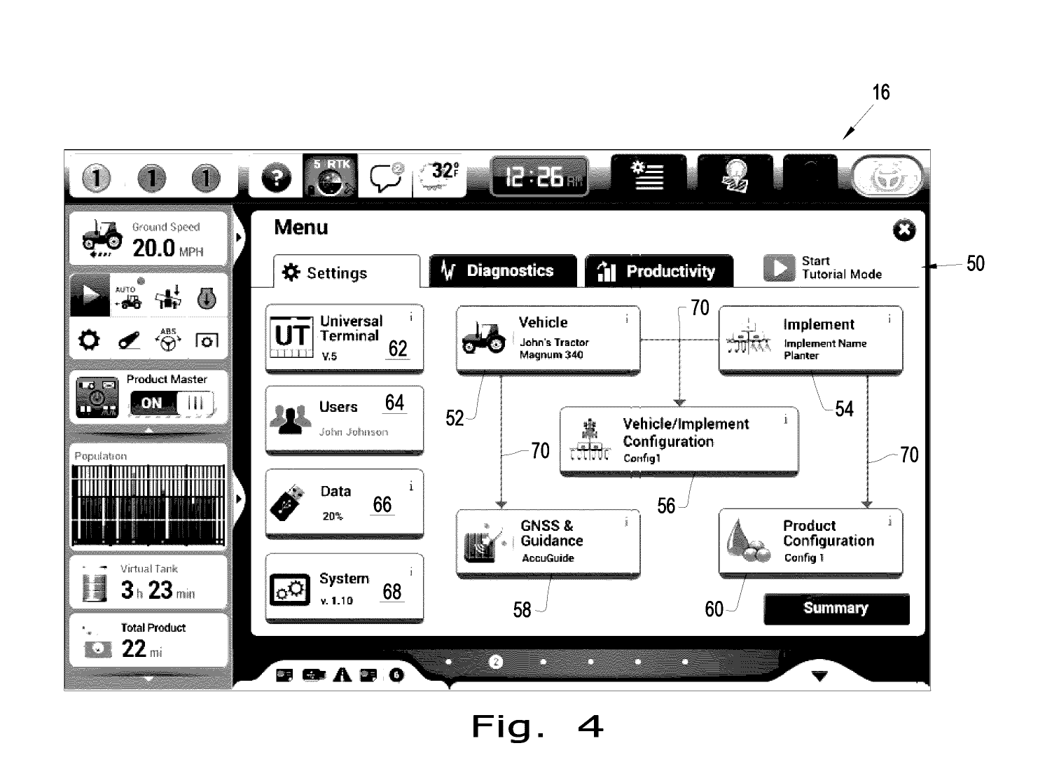

Now, additionally referring to FIGS. 3 and 4, there are illustrated information/selection screens that are provided by a Menu accessible from the Top Bar of the modular display. This window contains all system settings, diagnostics, and productivity reports, which allow users to switch between them. Within each tab 50, the content is logically grouped into multiple Cards 52, 54, 56, 58, 60, 62, 64, 66 and 68 (i.e. System, User Profile, Implement Setup etc.) by way of a card manager system carried out by controller 18. The layout is designed to help users intuitively understand the hierarchy of setups. Universal Terminal 62, User Profiles 64, Data Management 66 and System 68 cards are independent setups, whereas all other setup cards 52, 54, 56, 58, 60 have dependencies. The line and arrows 70 indicate the setup dependencies and suggested order, generally stated—a hierarchical layout.

The present invention detects the coupling of implement 14 and tractor 12 and identifies the relationships that previously existed when last coupled together. This includes assigning functions to valve controls and associated flow rates so that implement 14 will function in the same manner as when last connected. For example, a valve control may have been assigned to raise and lower a chisel plow when coupled to tractor 12, but now that planter 14 is coupled the same control may, for example, cause the marking device 38 to deploy or retract using a different fluid flow rate than used with the chisel plow. The flow rate of hydraulic fluid and the identification of the control are altered due to the detection of the connection of tractor 12 with implement 14.

Depending on the equipment coupled together such as tractor 12 and planter 14 the layout of the cards will differ, and yet have a combined layout that is unique for that selection of equipment (such as different layouts for Tractors, Integrated Sprayers, Combo Sprayers, Combines). Each Card 52, 54, 56, 58 and 60 includes a representative icon, a title and a summary of setups inside. The icon on the tabs can be changed dynamically depending on the selection within the card, i.e. red or blue tractor respectively for CaseIH and New Holland Tractors and an icon tractor of whichever color the user has selected for his 3rd party tractor. Upon pressing on the info button, in the top-right corner of each card, a pop-over menu (see card 56, FIG. 3) will show up and display the name of the setups (organized in tabs) that the card contains. Upon touching of the whole card, Detailed Setups open. By default the window shall always open on the first tab.

When the Menu cards have either encountered an error such as an invalid setup or the setup needs checking, the cards coloring will change from blue to either red or orange and may have a an exclamation symbol in a triangle (see card 52, FIG. 3) or in a circle (see card 56, FIG. 3). Along with the Menu Cards, the Indicators will appear on the Menu Button (see Settings tab in FIG. 3) in the Top Bar to show the user they have an error or they need to check their current settings. Invalid Indicators appear when a card is setup incorrectly. The Indicator will fade once the user corrects all the errors within the Card. Needs Checking (or recommended) indicators (see card 56, FIG. 3) appear when a user may need to check over the current settings. The Indicator will fade once more than one tab within the card has been pressed. This is to ensure that the user doesn't accidentally press the card and triggers indicators to fade without properly checking the flagged tabs. This also allows the user to avoid having to go through every tab that needs checking, if they already know that the tab is setup correctly. These illustrate a level of criticality relative to the need to check a setup or that more critically an error exists in a setup. For example, the level may be a recommended level or a required level of critically, to respectively recommend and require setup selections to be changed.

In FIG. 4 the alerts are all cleared, which shows that agricultural system 10 is configured to function. While there are no alerts, the setups may still be selected to vary the configurations as desired. The hierarchical implications of lines and arrows 70 are that certain setups are dependent on others. For example, the selection of a type of seed and chemical inputs in card 60 may require a reconfiguration of the implement 14 in card 54. The schematical or hierarchical layout also implies that the selection of a product configuration will have little or no impact on the vehicle card 52 and no implication of dependency is shown for the guidance card 58 relative to card 60.

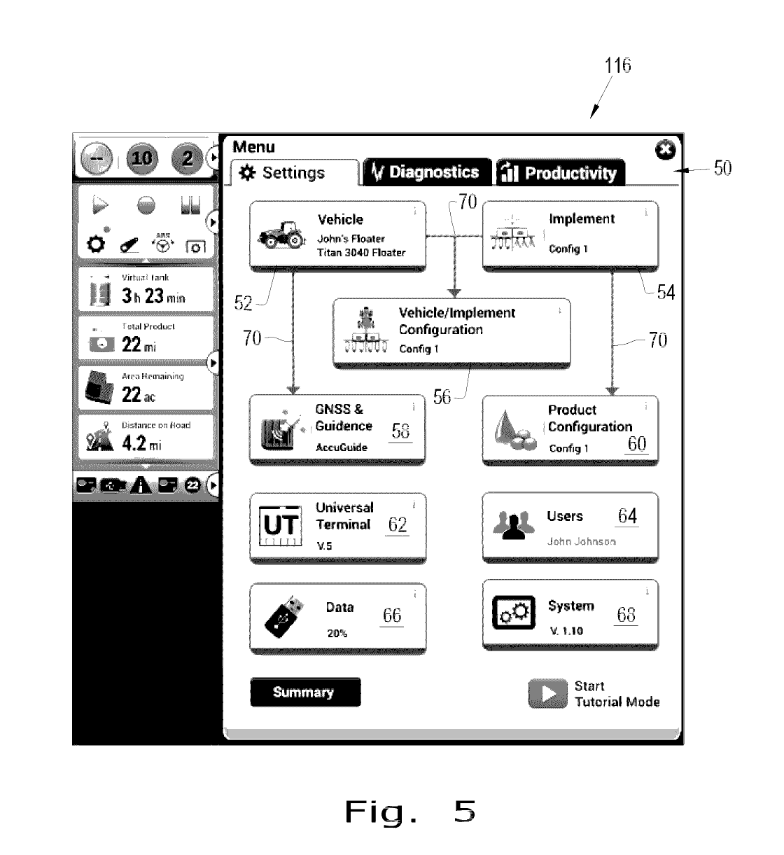

Now, additionally referring to FIG. 5, there is illustrated another display 116, with the elements of the previous two Figs. in a different layout. Here the hierarchical presentation of cards 52, 54, 56, 58 and 60 is positioned above cards 62, 64, 66, 68.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An agricultural system, comprising:
a vehicle;
a controller; and
a display mounted in said vehicle, said display being coupled to said controller, said controller being configured to interact with a user by way of said display using a card manager system, said card manager system being configured to display a hierarchy of setup selections on said display using a plurality of setup cards displayed in a hierarchical manner thereby implying dependency between underlying setup criteria of equipment represented by said setup cards.

2. The agricultural system of claim 1, wherein said cards each have an equipment identifier thereon.

3. The agricultural system of claim 2, wherein said plurality of cards displayed on said display include a first card and a second card, said hierarchy of setup selections further including an arrow connecting said first card to said second card thereby inferring that said first card should be setup before said second card.

4. The agricultural system of claim 3, wherein said plurality of cards display at least one of a symbol and an alerting color to indicate that setup is needed.

5. The agricultural system of claim 4, wherein said at least one of a symbol and an alerting color is one selection of a plurality of symbols and colors, each signifying a differing level of criticality.

6. The agricultural system of claim 5, wherein said level of criticality includes at least a required setup level, and a recommended setup level.

7. The agricultural system of claim 2, wherein said identifier includes a tractor icon with a color matching a selected tractor.

8. The agricultural system of claim 1, wherein each card includes an info button which upon being pressed opens a pop-over menu displaying the names of the setups associated with said card.

9. The agricultural system of claim 1, wherein upon pressing one of said cards detailed setups open.

10. The agricultural system of claim 1, wherein said hierarchy of setup selections additionally implies no dependency between certain of said plurality of cards.

11. A method of displaying information for an agricultural system that includes a vehicle, a controller and a display mounted in the vehicle, the controller being coupled to the display, the method comprising the steps of:
interacting with a user using a card manager system, said card manager system being configured to display a plurality of setup cards on said display; and
hierarchically displaying said plurality of cards with each card relating to a portion of the agricultural system thereby implying a dependency between at least some of said setup cards.

12. The method of claim 11, wherein said cards each have an equipment identifier thereon.

13. The method of claim 12, wherein said hierarchically displaying step includes linking at least two cards with a lined arrow thereby inferring that one card should be setup before the other card.

14. The method of claim 13, wherein said plurality of cards display at least one of a symbol and an alerting color to indicate that setup is needed.

15. The method of claim 14, wherein said at least one of a symbol and an alerting color is one selection of a plurality of symbols and colors, each signifying a differing level of criticality.

16. The method of claim 15, wherein said level of criticality includes at least a required setup level, and a recommended setup level.

17. The method of claim 12, wherein said identifier includes a tractor icon with a color matching a selected tractor.

18. The method of claim 11, wherein each card includes an info button which upon being pressed opens a pop-over menu displaying the names of the setups associated with said card.

19. The method of claim 11, wherein upon pressing one of said cards detailed setups open.

20. The method of claim 11, wherein said hierarchically displaying step additionally implies no dependency between certain of said plurality of cards.
